(19) United States
(12) Patent Application Publication
(10) Pub. No.: US 2011/0222287 A1
(43) Pub. Date: Sep. 15, 2011

(54) THREE-DIMENSIONAL OPTICAL DISPLAY DEVICE

(75) Inventor: Chia-Ying LEE, Taipei County (TW)

(73) Assignee: LEDGEND TECHNOLOGY INC., Taipei County 241 (TW)

(21) Appl. No.: 12/791,540

(22) Filed: Jun. 1, 2010

(30) Foreign Application Priority Data
Mar. 9, 2010 (TW) 099204096

(51) Int. Cl. F21V 21/00

(52) U.S. Cl. 362/249.06

(57) ABSTRACT

A three-dimensional light-source display device enables light sources to present a three-dimensional display effect in a three-dimensional space. In general, a single light-source display module is used to complete a uniaxial (Y axis) arrangement of light sources, and after the arrangement of a plurality of the light-source display modules is completed, a plurality of the light-source display modules are further arranged to form two-dimensional (X axis and Y axis) and three-dimensional (X axis, Y axis, and Z axis) arrangements. The present invention can further generate a three-dimensional display effect through a circuit design and programmable control.

### BACKGROUND OF THE INVENTION

1. Field of the Invention

The present invention relates to a three-dimensional light-source display device capable of presenting a three-dimensional visual effect after current conduction, and more particularly to a three-dimensional light-source display device having a circuit board, which is capable of presenting a three-dimensional visual effect.

2. Related Art

Besides illumination and detection, light sources are also currently widely applied to requirements of situations, ambience and display. Light sources for situations or ambience include common ambient lamps and projector lamps on exterior walls of buildings, and light sources capable of changing the light color for indoor use. Light sources for display had also found wide applications, and include common light emitting diode (LED) marquee signs and planar display lamp panels. The layout of this type of light sources is mainly configured in a two-dimensional manner, that is, mainly aims to generate a surface light source, and then a driving integrated circuit (IC) and programmable control are further provided, such that the surface light source can be changed according to the requirements. However, the display of this type can only achieve planar presentation and change of the light source, that is, the display surface is only a single plane.

In order to enable the light source display of this type to achieve a three-dimensional effect, relevant technologies have been disclosed, for example, U.S. Pat. No. 7,190,328 “THREE-DIMENSIONAL DISPLAY”, US2007/0024525 “THREE-DIMENSIONAL DISPLAY”, and US2007/0024526 “THREE-DIMENSIONAL DISPLAY”, that is, a three-dimensional light-source display has been disclosed. However, for the technologies disclosed in the above issued or published patents, a plurality of brackets is used, and configured in a three-dimensional staggering manner, and then LEDs are respectively electrically configured on electrodes at staggering positions of the brackets, and related circuit design and program are further provided, such that when the LEDs generate light sources, a visual effect of three-dimensional display can be formed.

Based on the above, although all the patents have specifically disclosed the generation and structure of the three-dimensional light source, the structure disclosed by the patents is rather complex, and the following problems will inevitably occur if products are produced according to the patents.

(1) The brackets are elongated, and thus are easily bent or broken due to undue external forces during assembly.

(2) The staggered configuration of the brackets requires the use of a variety of tools, and may have to be carried out manually, which is not suitable for mass production.

(3) When the LEDs are configured on the brackets, the LEDs are easily interfered with the staggered brackets, resulting in assembly difficulty and generation of undesired products.

(4) Due to the staggered configuration of the brackets, when the LEDs generate light sources, light shading easily occurs.

(5) Due to the above problems, the volume of final products cannot be maximized or minimized.

### SUMMARY OF THE INVENTION

In view of the above problems, the present invention is mainly directed to a three-dimensional light-source display device that is easy to assemble, has a desired display effect, and can be modularized.

In order to achieve the above objectives, the present invention mainly uses a circuit board technology. A plurality of LEDs is arranged and configured on a circuit board in a uniaxial (Y axis) arrangement manner, so as to form a light-source display module. Further, a plurality of the light-source display modules is electrically connected to a support base having a circuit design, such that the light-source display modules form a second-dimensional or third-dimensional arrangement, thereby forming a three-dimensional light-source display device. After current conduction, the three-dimensional light-source display device can generate changes of light sources according to the circuit design and a preset program, and the generated light sources can be combined to form a three-dimensional image.

In order to make the structure and effects of the present invention more comprehensible, the present invention is described below with reference to the accompanying drawings.

### BRIEF DESCRIPTION OF THE DRAWINGS

The present invention will become more fully understood from the detailed description given herein below for illustration only, and thus are not limitative of the present invention, and wherein:

FIG. 1 is a three-dimensional outside view (1) of the present invention;

FIG. 2 is a three-dimensional outside view (2) of the present invention;

FIG. 3 is a three-dimensional outside view (3) of the present invention;

FIG. 4 shows another preferred embodiment (1) of the present invention;

FIG. 5 shows another preferred embodiment (2) of the present invention;

FIG. 6 shows another preferred embodiment (3) of the present invention;

FIG. 7 is a three-dimensional outside view (1) of the preferred embodiment (3);

FIG. 8 is a three-dimensional outside view (2) of the preferred embodiment (3);

FIG. 9 is a three-dimensional outside view (3) of the preferred embodiment (3);

FIG. 10 shows another preferred embodiment (4) of the present invention;

FIG. 11 shows another preferred embodiment (5) of the present invention;

FIG. 12 is a schematic view of implementation of the preferred embodiment (5); and

FIG. 13 shows another preferred embodiment (6) of the present invention.

### DETAILED DESCRIPTION OF THE INVENTION

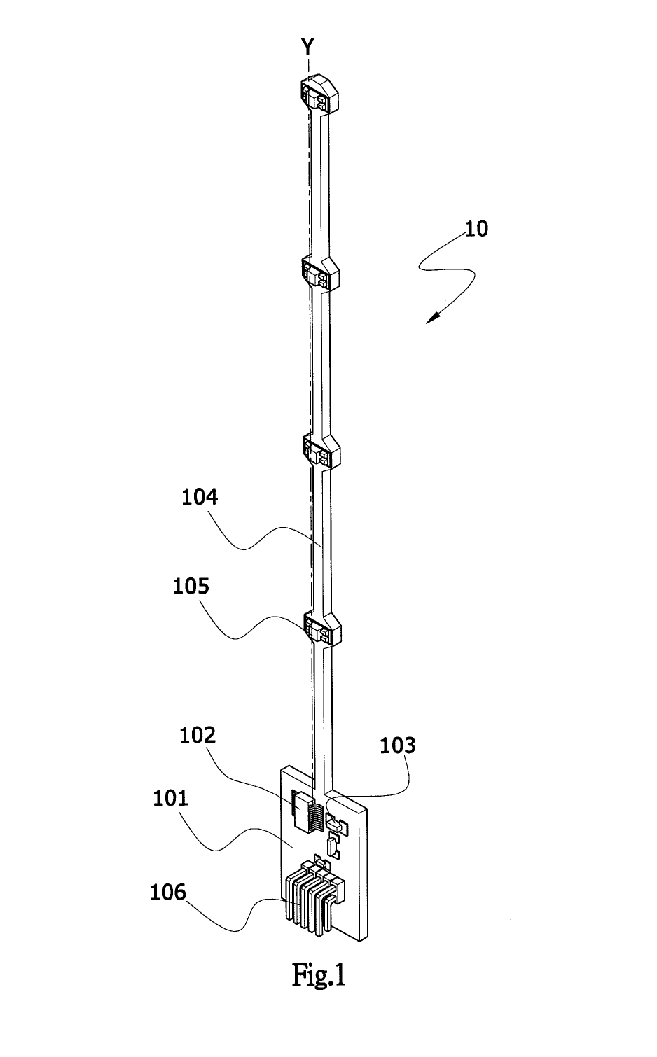

FIG. 1 is a three-dimensional outside view (1) of the present invention. Referring to FIG. 1, a three-dimensional light-source display device of the present invention is mainly formed by a plurality of light-source display modules 10. The light-source display module 10 mainly includes a circuit board 101, and a circuit and related electronic elements (102 and 103 as shown in the figure) are laid out on a surface of the circuit board 101. A bracket body 104 is formed on one edge of the circuit board 101. More than one LED 105 is configured on a single surface or two surfaces of the bracket body 104 and spaced from one another. The LEDs 105 may be single-chip (single-color) or multi-chip (multi-color, for example, R, G, and B) LEDs. Referring to FIG. 1 again, an electrical pin 106 is configured on a surface of the circuit board 101 adjacent to a bottom edge as shown in the figure. Therefore, through the arrangement of the LEDs 105 on the bracket body 104, the configured LEDs 105 form a uniaxial (Y axis as shown in the figure) arrangement.

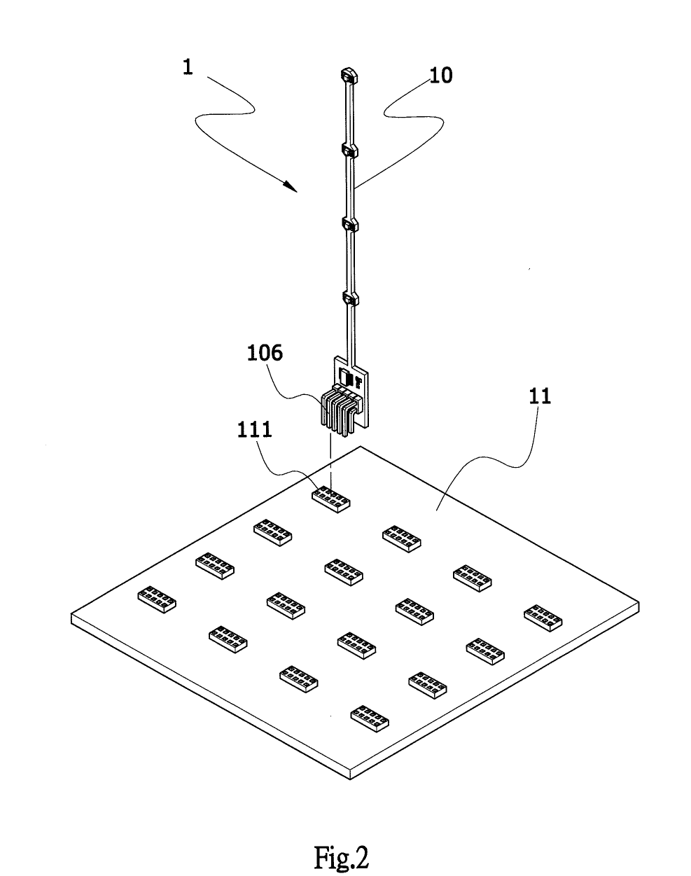

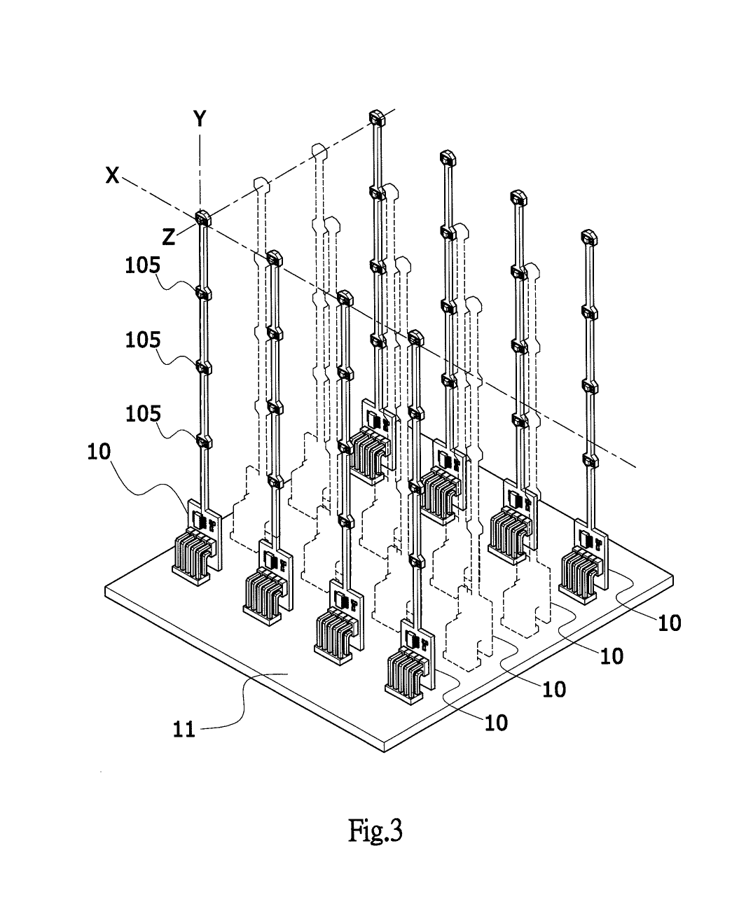

FIG. 2 is a three-dimensional outside view (2) of the present invention. Referring to FIG. 2, the light-source display module 10 of the present invention is further inserted into a support base 11. The support base 11 at least includes a circuit design, a power input end and a power output end (not shown), and more than one electrical connection port 111 is configured on a surface of the support base 11. Referring to FIG. 2 again, during configuration, the electrical pin 106 of the light-source display module 10 is placed corresponding to the electrical connection port 111 of the support base 11, and the electrical pin 106 is inserted into the electrical connection port 111, thereby electrically connecting the two. FIG. 3 is a three-dimensional outside view (3) of the present invention. Referring to FIG. 3, after a plurality of the light-source display modules 10 is configured on the support base 11, as shown in the figure, the LEDs 105 of a single light-source display module 10 form a uniaxial (Y axis) arrangement, and the arrangements of the plurality of the light-source display modules 10 further form a second dimension (X axis) and a third dimension (Z axis). As such, for visual presentation, a three-dimensional display body is formed. In addition, as shown in the figure, the number of the LEDs 105 of a single light-source display module 10 is 4, and (4×4) 16 light-source display modules 10 are used in combination, so that the presentation of a 4×4×4 cube is formed. The present invention can further change the combination manner according to requirements, for example, into presentation of an 8×8×8 cube, or a combination manner of other numbers, and the volume can be enlarged or reduced according to actual display requirements. Therefore, the number is merely provided for illustrating the implementation of the present invention, but not intended to limit the implementation and scope of the present invention.

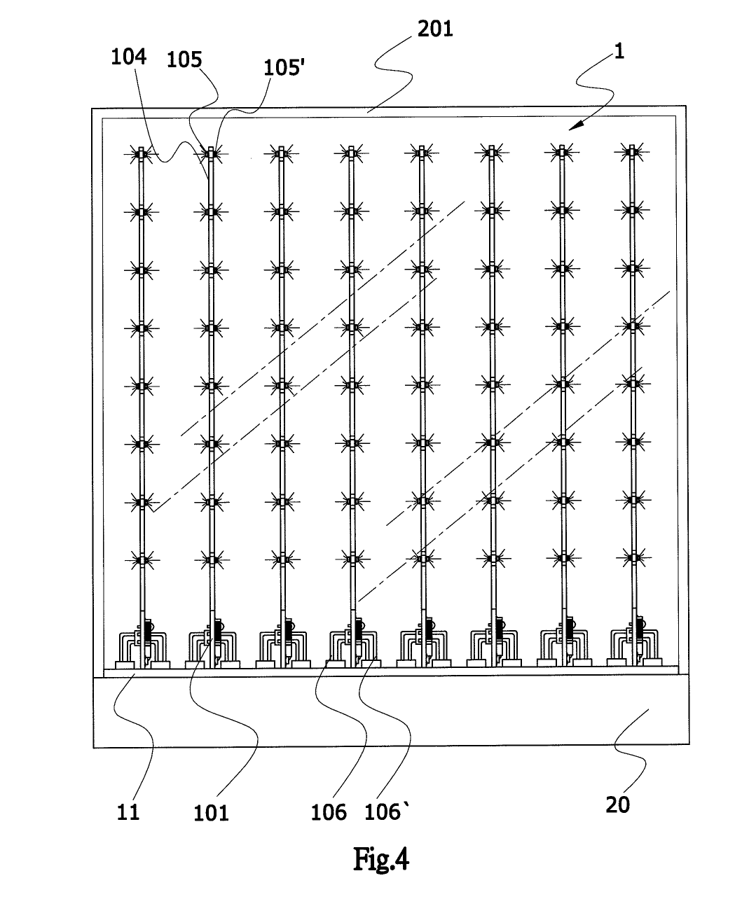

FIG. 4 shows another preferred embodiment (1) of the present invention. Referring to FIG. 4, in order to avoid a dead angle during presentation when the light color changes, LEDs (105 and 105′) are respectively configured on two surfaces of the bracket body 104 of the circuit board 101 in this embodiment (1), and LEDs having a large light emitting angle may be used, for example, LEDs having a light emitting angle of 120° to 180° are most preferably used. As the number of the LEDs (105 and 105′) increases, and the LEDs are respectively laid out on the two surfaces, in order to achieve the best electrical control state, the layout of related electronic units such as electrical pins (106 and 106′) as shown in the figure may be added according to the circuit design, so as to optimize the implementation effect. Referring to FIG. 4 again, the support base 11 of the present invention is further configured in a seat 20, such that the entire three-dimensional light-source display device 1 is fixed on the seat 20. The seat 20 is configured with a light transmissive cover 201. The seat 20 may be configured on a surface such as a ceiling, table surface or wall surface. Since the LEDs (105 and 105′) are respectively configured on the two surfaces of the bracket body 104, nearly no dead angle exits when the light color is presented, that is, a viewer can see the change of the light color no matter where the view stands. The change of the light color includes, for example, a color change, an image effect produced by lighting on and off, and a marquee sign form.

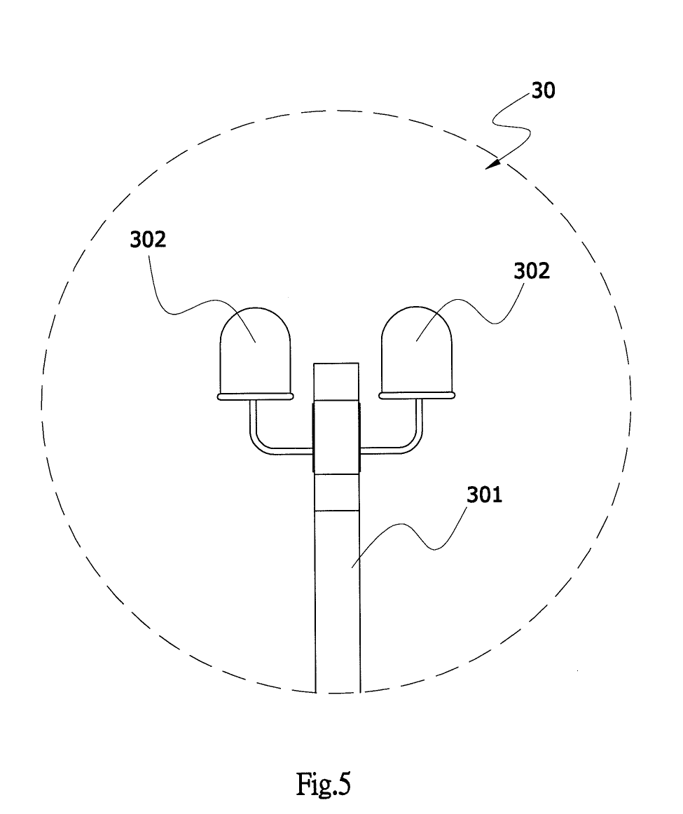

FIG. 5 shows another preferred embodiment (2) of the present invention. The present invention can further use other forms of LEDs for electrical connection on the bracket body, for example, a plurality of bulb-like LEDs 302 are respectively electrically connected on two surfaces of a bracket body 301 of a light-source display module 30 as shown in the figure, and a user can lay out different forms of light emitting sources on the bracket body 301 according to actual requirements.

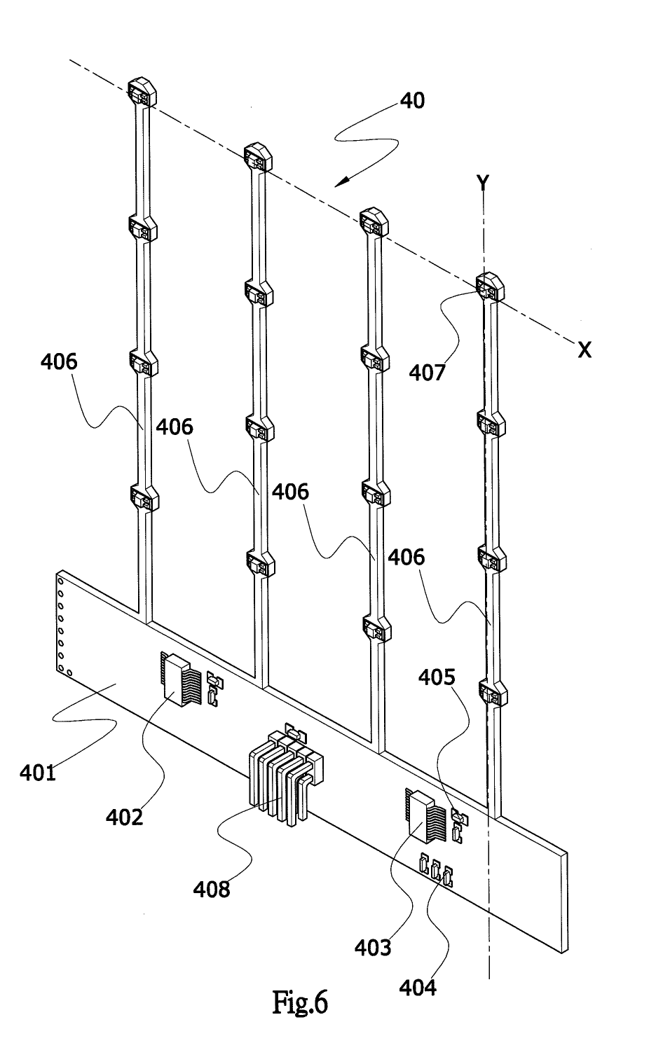

FIG. 6 shows another preferred embodiment (3) of the present invention. Referring to FIG. 6, a light-source display module 40 mainly includes a circuit board 401, and a circuit and related electronic elements (402-405 as shown in the figure) are laid out on a surface of the circuit board 401. A plurality of bracket bodies 406 is formed on one edge of the circuit board 401, and the bracket bodies 406 are spaced from one another by a suitable distance. More than one set of LEDs 407 is configured on a single surface or two surfaces of each separate bracket body 406 and spaced from one another. The LEDs 407 may be single-chip (single-color) or multi-chip (multi-color, for example, R, G, and B) LEDs. Referring to FIG. 6 again, an electrical pin 408 is configured on a surface of the circuit board 401 adjacent to a bottom edge. Therefore, through the arrangement of the circuit board 401 and the bracket bodies 406, the configured LEDs 407 form a two-dimensional (X axis and Y axis as shown in the figure) arrangement.

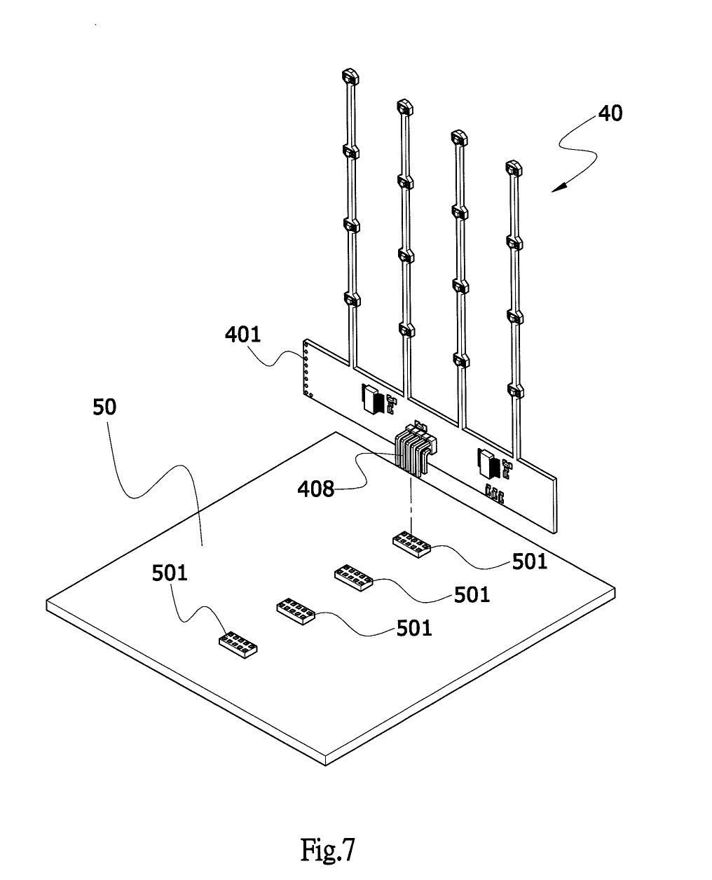

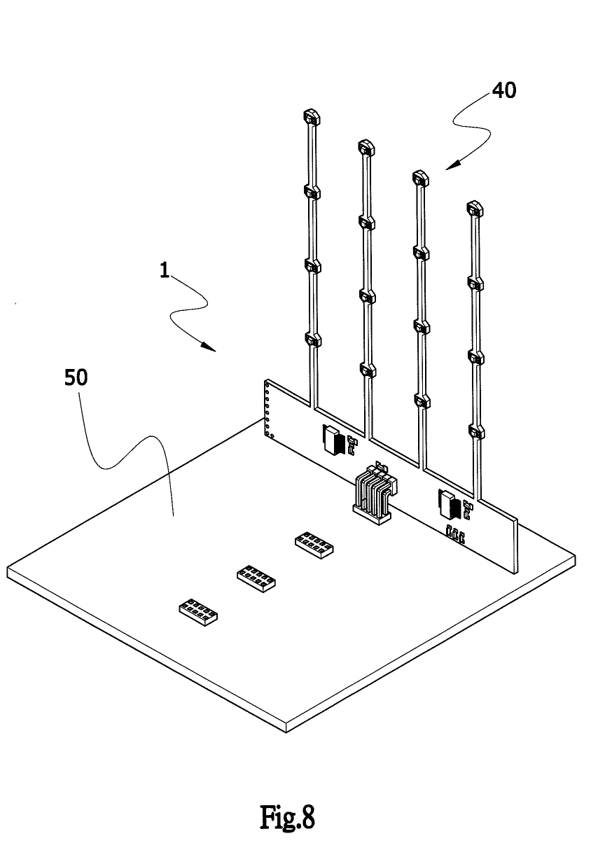

FIG. 7 is a three-dimensional outside view (1) of the preferred embodiment (3). Referring to FIG. 7, the light-source display module 40 of the present invention is further inserted into a support base 50. The support base 50 at least includes a circuit design, a power input end and a power output end (not shown), and more than one electrical connection port 501 is configured on a surface of the support base 50. Referring to FIG. 7 again, during configuration, the electrical pin 408 of the light-source display module 40 is placed corresponding to the electrical connection port 501 of the support base 50, and the electrical pin 408 is inserted into the electrical connection port 501, thereby electrically connecting the two. After the configuration of the single light-source display module 40 is completed, the structure is as shown in FIG. 8, which is a three-dimensional outside view (2) of the preferred embodiment (3).

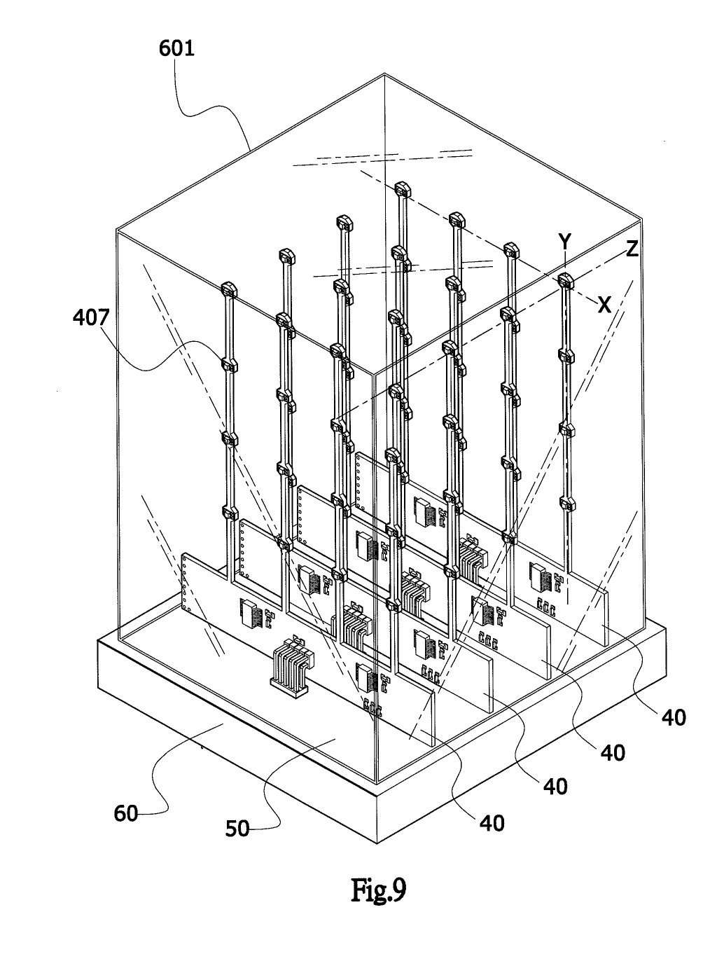

FIG. 9 is a three-dimensional outside view (3) of the preferred embodiment (3). Referring to FIG. 9, a display base 60 is configured with the support base 50 therein. After a plurality of the light-source display modules 40 is configured on the support base 50, as shown in the figure, the LEDs 407 of a single light-source display module 40 form a two-dimensional (X axis and Y axis) arrangement, and the arrangements of the plurality of the light-source display modules 40 further form a third dimension (Z axis). As such, for visual presentation, a three-dimensional display body is formed. Moreover, in this embodiment, a cover 601 may be further covered on the display base 60, so as to protect the components of the three-dimensional light-source display device. In addition, as shown in the figure, this embodiment can also change the combination manner according to requirements, for example, into presentation of a 4×4×4 cube, or a combination manner of other numbers, and during production, the volume can be enlarged or reduced according to actual display requirements.

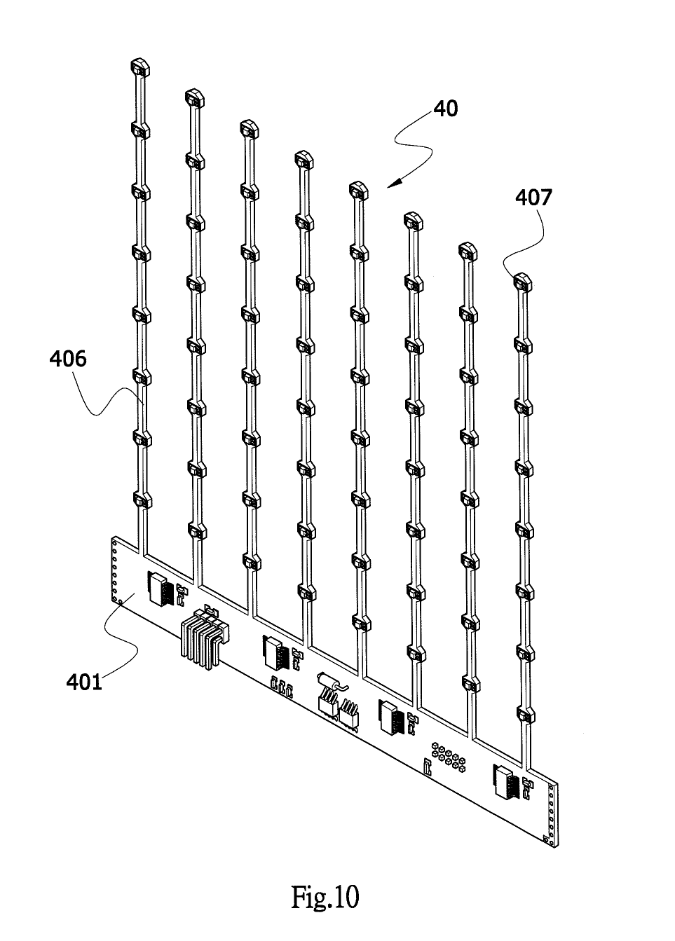

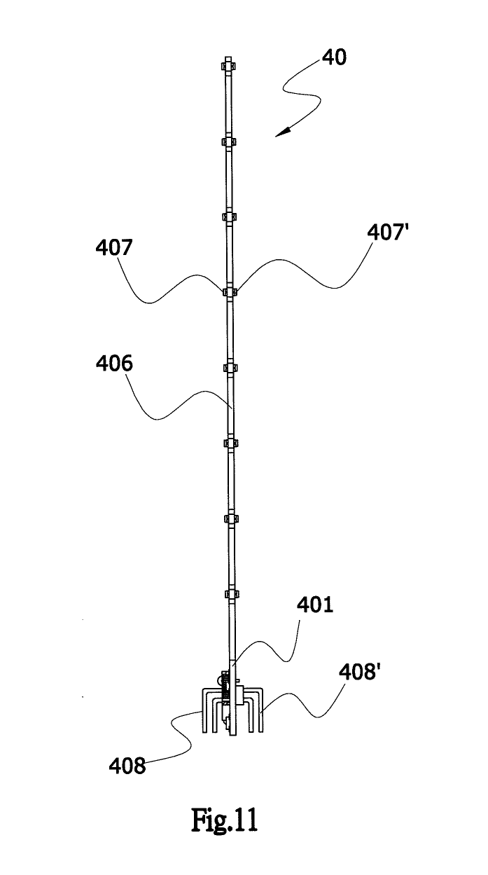

FIG. 10 shows another preferred embodiment (4) of the present invention. Referring to FIG. 10, an 8×8 entity is presented, in which the bracket body 406 of the light-source display module 40 is configured with 8 LEDs 407, so as to increase the change and fineness when the light color is displayed. FIG. 11 shows another preferred embodiment (5) of the present invention. Referring to FIG. 11, LEDs (407 and 407′) are respectively further configured on two surfaces of the bracket body 406 of the circuit board 401 in this embodiment (5), and LEDs having a large light emitting angle may be used. In order to achieve the best electrical control state, the layout of related electronic units such as electrical pins (408 and 408′) as shown in the figure may be added according to the circuit design, so as to optimize the implementation effect.

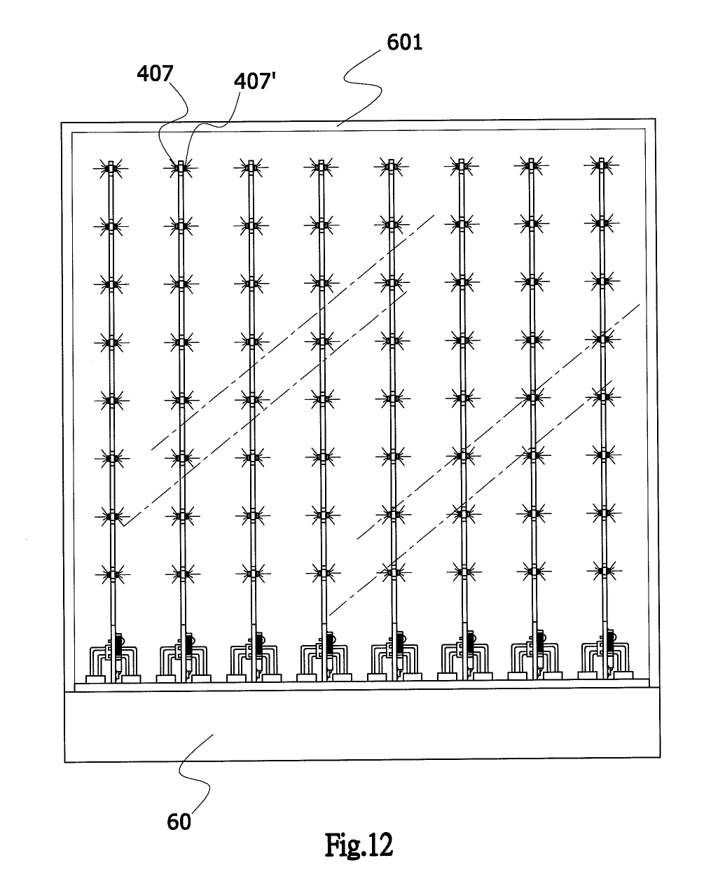

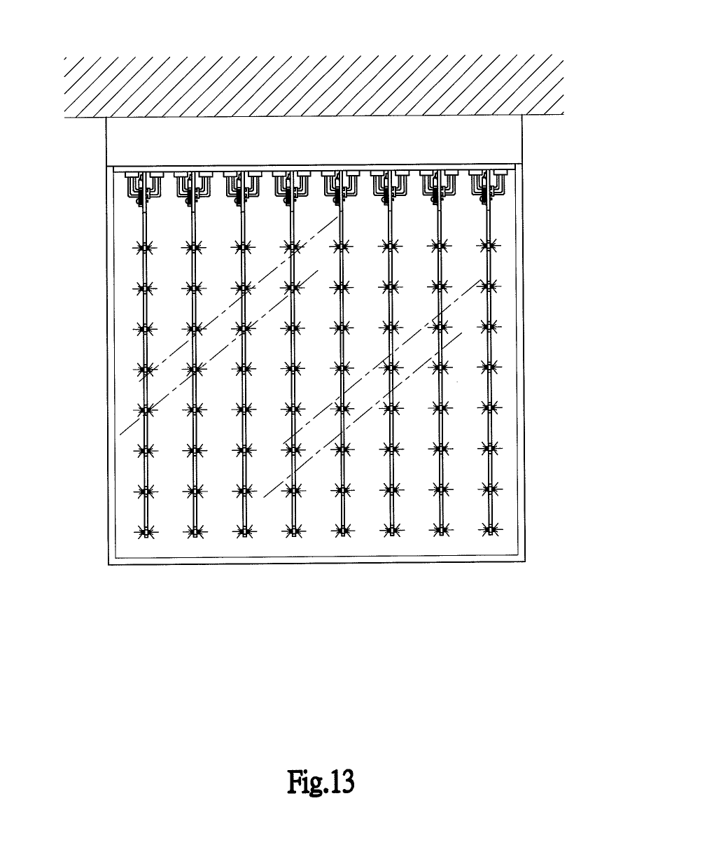

FIG. 12 is a schematic view of implementation of the preferred embodiment (5). Referring to FIG. 12, in order to enable this embodiment to achieve desirable appearance and display effect, this embodiment is further configured in the display base 60, the display base 60 is placed on a surface such as a table surface (may also be configured on a ceiling or wall surface as described above), and the cover 601 is covered on the display base 60, such that a viewer can see the change of the light color no matter where the view stands, thereby avoiding occurrence of a dead angle. FIG. 13 shows another preferred embodiment (6) of the present invention. The three-dimensional light-source display device of the present invention can be configured on any surface such as a ceiling, table surface or wall surface. As shown in the figure, the three-dimensional light-source display device is configured (suspended) on a ceiling.

To sum up, in the three-dimensional light-source display device of the present invention, a circuit board is mainly used to fabricate a light-source display module such that a uniaxial arrangement of a plurality of LEDs can be completed in advance, and then a plurality of the light-source display modules is configured on a support base having a circuit layout, so as to form a layout in a second dimension or third dimension, thereby fabricating a three-dimensional light-source display device. The present invention at least has the following advantages.

(1) The circuit substrate technology is quite mature at present, and through the structure disclosed in the present invention, the advantages of rapid production and high yield can be achieved.

(2) After a plurality of light-source display modules having a surface light source is arranged, a three-dimensional display light source in three dimensions is formed. Since the bracket bodies do not need to be staggered, the light shading problem of the light source is substantially eliminated.

(3) The circuit boards are separate, are manufactured by the same process, and can be simply configured by modularization according to actual requirements, allowing for numerous variations of the physical product. For example, the volume can be changed according to actual requirements.

(4) For the strength of the circuit board, the material can be selected according to actual volume requirements, and the strength can meet the requirements of the physical product after configuration.

Thus, after the three-dimensional light-source display device of the present invention is implemented accordingly, the objective of providing a three-dimensional light-source display device that is easy to assemble, has a desired display effect, and can be modularized can surely be achieved.

The above descriptions are merely preferred embodiments of the present invention, but are not intended to limit the present invention. Any equivalent variation and modification made by persons skilled in the art without departing from the spirit and scope of the present invention shall fall within the appended claims of the present invention.

What is claimed is:

1. A three-dimensional light-source display device, capable of generating a light-source display in three dimensions after configuration and current conduction, comprising:
a light-source display module, having a circuit board, wherein a bracket body is formed on one edge of the circuit board, a plurality of light emitting diodes (LEDs) is laid out on a surface of the bracket body and spaced from one another such that each of the LEDs forms a surface light source in a uniaxial direction after the layout is completed, and an electrical pin is configured on a surface of the circuit board;
a support base having a circuit, wherein more than one electrical connection port is configured on a surface of the support base, and the electrical connection port is electrically connected to the circuit of the support base; and
a plurality of the light-source display modules, respectively inserted into the electrical connection port of the support base through the electrical pin, such that after the insertion is completed, the LEDs present a layout in three dimensions.

2. The three-dimensional light-source display device according to claim 1, wherein the circuit board is configured with a plurality of electronic elements.

3. The three-dimensional light-source display device according to claim 1, wherein two surfaces of the bracket body of the circuit board are respectively configured with a plurality of LEDs.

4. The three-dimensional light-source display device according to claim 1, wherein two surfaces of the circuit board are respectively configured with an electrical pin.

5. The three-dimensional light-source display device according to claim 1, wherein the support base is configured in a seat.

6. The three-dimensional light-source display device according to claim 5, wherein the seat is configured with a light transmissive cover.

7. The three-dimensional light-source display device according to claim 1, wherein the LEDs are multi-chip LEDs.

8. The three-dimensional light-source display device according to claim 1, wherein the LEDs are bulb-like LEDs.

9. The three-dimensional light-source display device according to claim 1, wherein the LED has a light emitting angle of 120° to 180°.

10. The three-dimensional light-source display device according to claim 1, wherein a plurality of the bracket bodies is formed on one edge of the circuit board.
